(19) United States
(12) Patent Application Publication
(10) Pub. No.: US 2014/0137192 A1
(43) Pub. Date: May 15, 2014

(54) System and Method for Authenticating Email Messages from Trusted Sources

(71) Applicant: Javier Armando Arroyo-Figueroa, Gainesville, FL (US)

(72) Inventor: Javier Armando Arroyo-Figueroa, Gainesville, FL (US)

(73) Assignee: ENTEVIA, LLC, Gainesville, FL (US)

(21) Appl. No.: 14/066,664

(22) Filed: Oct. 29, 2013

Related U.S. Application Data
(60) Provisional application No. 61/722,232, filed on Nov. 4, 2012.

(51) Int. Cl. H04L 29/06

(52) U.S. Cl. CPC H04L 63/123; H04L 63/08
USPC 726/3

(57) ABSTRACT

A system and method for authenticating email messages from trusted sources. A trusted sender (TS) registers at a Trusted Validator (TVAL). The TVAL performs a one-time validation of the TS's identity, and creates a public access URL and private application key for the TS. The TS uses the private application key to generate, for each email message/address pair, a unique message access URL. The message access URL is inserted, along a text containing instructions, at the top of the email message to be sent. The public access URL is published by the TS (typically at the TS's web site) for the message receiver (MR) to associate the TS with his/her account in the TVAL. The MR obtains an authentication cookie for his/her email address at the TVAL, and, for each TS, he/she registers a “key phrase” only known to the MR in relationship with the TS. When the email message is opened by the MR, the email client uses the message access URL to obtain from the TVAL (if an authentication cookie has previously been created) the MR's key phrase in the form of a human-readable (but machine-non-readable) form. The MR authenticates the message as trusted by identifying the key phrase associated with the TS.

This USA Patent Application represents a non-provisional application claiming benefit from continuation of Provisional Patent Application No. 61/722,232, filed on Nov. 4, 2012.

### TECHNICAL FIELD

The present invention relates to the field of computing, more specifically to a system and method for authenticating email messages from trusted sources.

### BACKGROUND

Email spoofing and phishing are common problems faced by many institutions that use email for sending official communications to their users. With a spoofed email, a hacker can “phish” an unsuspecting user of an institution by luring him/her to a website that mimics the institution's web site. The deceiving web site would request sensitive information from the user, such as a user id, password or account number. As a result, millions of dollars are lost by identity theft and unauthorized transactions.

There are many approaches to solve this problem, each one with its advantages and pitfalls. Phishing filters, though popular among all web browsers, usually depend in identifying patterns and identities previously recognized as threats by external validation entities; the problem with this approach is that it might be too late before such patterns and identities are identified, as they rely on cooperation among validation entities. E-mail filters also depend in said validation entities, thus they suffer from the same “identification delay” problem. Sender authentication through protocols like SPF, Sender ID and Domain Keys/DKIM, although useful for authenticating a sender at the email message header's level, do nothing to protect the receiver from deceiving email addresses like sender@yuorbank.com (spoofed) vs. sender@yourbank.com (valid), both of which may be authenticated correctly under such protocols.

### BRIEF SUMMARY

The invention is a system and method for authenticating email messages from trusted sources. A trusted sender (TS) registers at a Trusted Validator (TVAL). The TVAL performs a one-time validation of the TS's identity, and creates a public access URL and private application key for the TS. The TS uses the private application key to generate, for each email message/address pair, a unique message access URL. The message access URL is inserted, along a text containing instructions, at the top of the email message to be sent. The public access URL is published by the TS (typically at the TS's web site) for the message receiver (MR) to associate the TS with his/her account in the TVAL. The MR obtains an authentication cookie for his/her email address at the TVAL, and, for each TS, he/she registers a “key phrase” only known to the MR in relationship with the TS. When the email message is opened by the MR, the email client uses the message access URL to obtain from the TVAL (if an authentication cookie has previously been created) the MR's key phrase in the form of a human-readable (but machine-non-readable) form. The MR authenticates the message as trusted by identifying the key phrase associated with the TS.

### BRIEF DESCRIPTION OF THE DRAWINGS

FIG. 1. System Architecture

FIG. 2. Trusted Sender Registration Process

FIG. 3. User Account Access Process

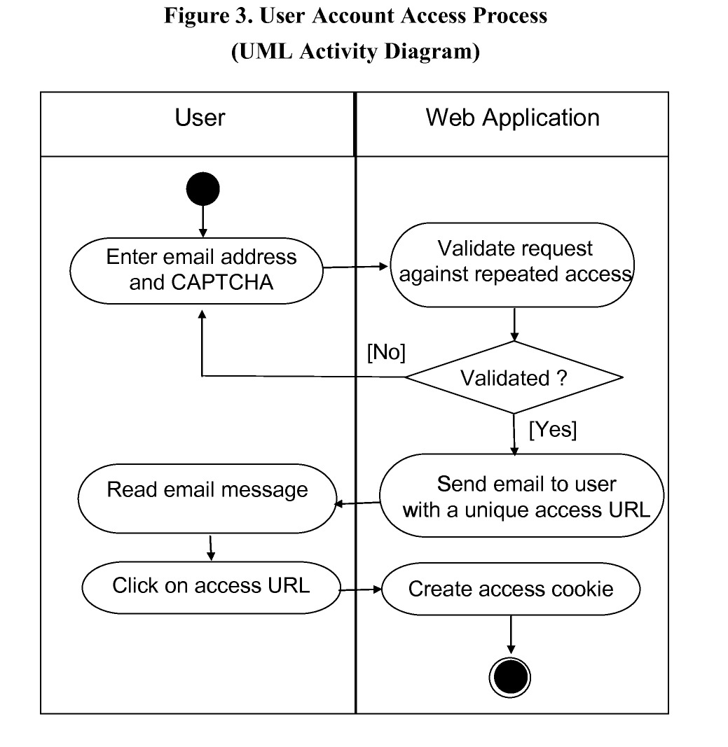

FIG. 4. Trusted Sender Registration Process

FIG. 5. Email Authentication Process

### DETAILED DESCRIPTION

System Architecture

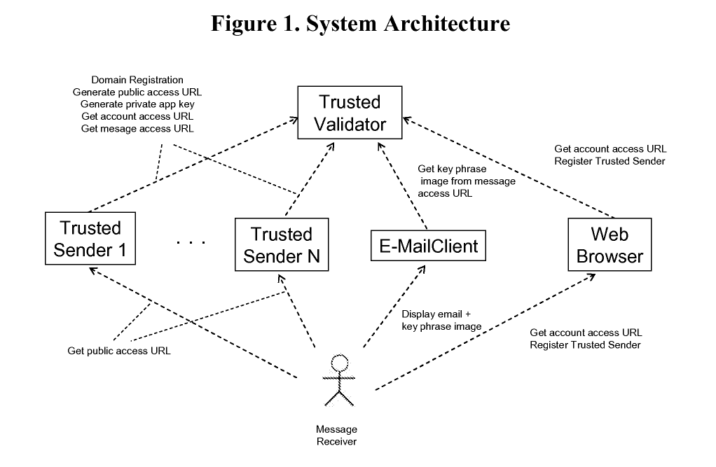

A diagram depicting the system architecture is presented in FIG. 1. The following is a description of the system components and their relationships:

Trusted Validator (TVAL): A component responsible for (i) registering trusted senders (TSs); (ii) providing functionalities for each MRs to register its email and list of TSs and associated key phrases; (iii) generating and keeping, for each TS, a public access URL and a private application key; (iv) generating a unique message access URL for each message/email pair; (v) generating a unique account access cookie for each authenticated user; and (vi) generating a key phrase image from a unique message access URL and account access cookie.

Trusted Sender (TS): An entity that sends an email message, registered as a Trusted Sender in the TVAL.

Message Receiver (MR): The user receiving a message form a TS.

E-Mail Client: A program that runs in a machine accessed by the MR, reading and displaying email messages to the MR.

Web Browser: A typical web browser, in this context used to access the TVAL's functionalities.

Trusted Sender Registration Process

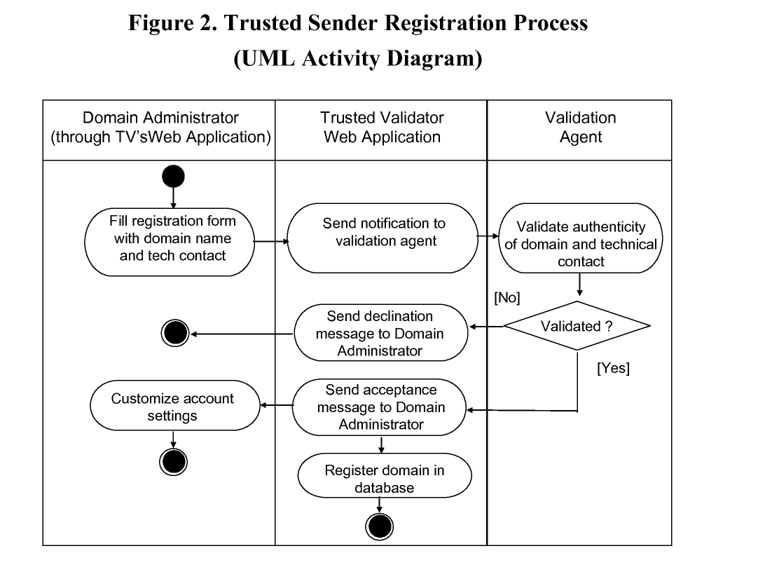

A UML Activity diagram depicting the Trusted Sender Registration Process is presented in FIG. 2. The process starts by the Domain Administrator accessing the TVAL Web Application's domain registration functionality. The Domain Administrator, through the system's Web Application, registers by entering the domain name and primary contact information. A notification is sent to a Validation Agent, who will validate the application by contacting the Domain Administrator and requiring validation information, such as proof of domain ownership and the identity of the entity owning the domain. If validation does not succeed, a declination message is sent to the Domain Administrator; otherwise, an acceptance notice is sent, and the domain is registered into the database.

User Account Access Process

A UML Activity diagram depicting the User Account Access Process is presented in Error! Reference source not found.. The process applies to both Domain Administrator and Message Receiver accounts. It starts by the User accessing the TVAL Web Application's account access functionality. The User enters his/her email address and a code from a CAPTCHA image. The Web Application validates the request against repeated access. If the request is invalid, the user will be requested to enter the information again. Otherwise, a unique access URL will be sent to the email address provided by the User. Upon receipt of the email message, the User clicks on the unique access URL, which will grant access to the User by creating a unique access cookie stored by the User's web browser.

Trusted Sender Registration Process

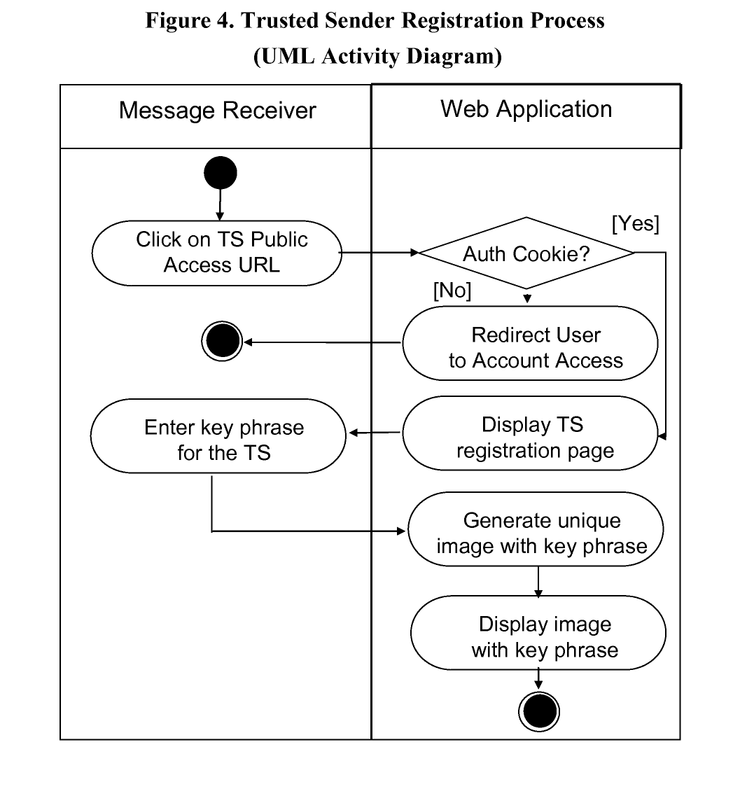

A UML Activity diagram depicting the Trusted Sender (TS) Registration Process is presented in FIG. 4. The process starts by the MR clicking on the TS's Public Access URL. If the MR does not have an authorization cookie, he/she will be redirected to the Account Access page of the TVAL Web Application. Otherwise, a TS registration page will be displayed, in which the MR enters the key phrase associated with the TS (only know to the MR, such as “Daddy's Preferred Bank”, which will help the MR identify the TS as trusted. The Web Application generates a unique image containing the key phrase entered by the MR, and will display it.

Other Trusted Sender Processes

There are other TS processes to be supported by the system. Since there are single-step processes, there is no need to have a diagram for them, and are explained below. All processes assume that the TS has been authenticated.

Generate Public Access URL: Generate an URL to be used by MRs to register the TS as trusted for the MR's email address.

Generate Private Application Key: Generate a unique private application key, to be used by the TS when generating unique message access URLs.

Generate Message Access URL: Generate a unique message access URL by passing: (i) the MR's email address; and (ii) the TS's private application key. The URL is to be inserted at the beginning of the message body; it may be preceded by instructions such as “Please authenticate sender by verifying your key phrase in the image below”.

Email Authentication Process

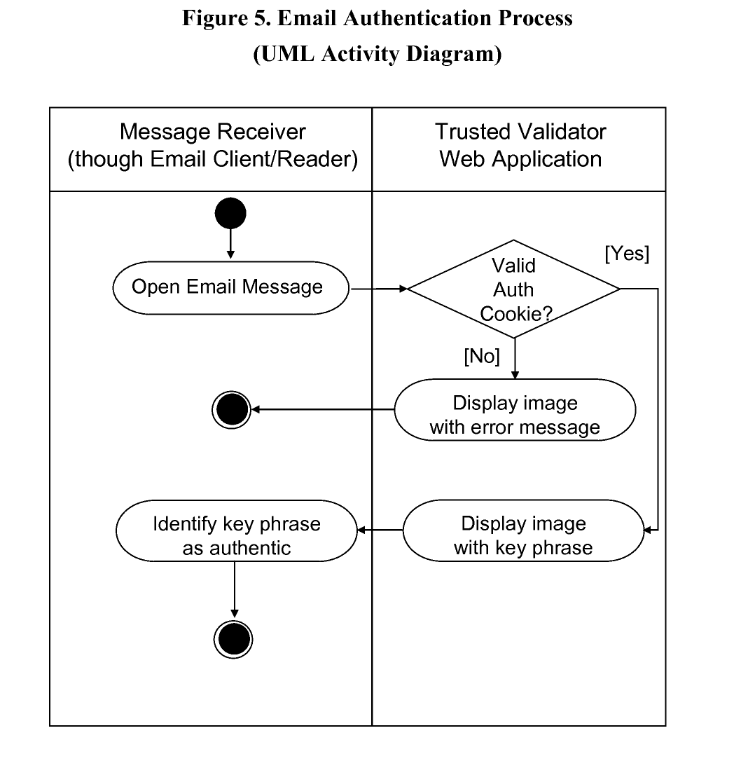

A UML Activity diagram depicting the Email Authentication Process is presented in FIG. 5. The process starts by the MR opening an email message in his/her email client. An authentic email message will contain a unique message access URL, which should display an image obtained from the TVAL Web Application; the image contains the key phrase (assumed to be known only by the MR) identifying the sender as authentic. The MR should allow the email client to display images. If the user does not have a valid authorization cookie, an image with an error message will be displayed. Otherwise, an image containing the key phrase for the sender will be displayed. The MR validates the authenticity of the sender by identifying the key phrase as valid.

What is claimed is:

1. A computer-based system for authenticating email messages from trusted sources, said system comprising:
a. A Trusted Validator (TVAL), recognized as such by Trusted Sources (TSs) and Message Receivers (MR), providing functionalities for (i) certifying and validating TSs; (ii) authenticating users by means of a unique authorization cookie, created from a URL sent to the user's email; (iii) generating a private application key for each TS, only known to the TS; (iv) generating, for each message sent by a TS to a MR, a unique message access URL, upon validation of the TS's application key; (v) storing, for each MR, a set of images, each one displaying a key phrase only known to the MR for each TS to be trusted by the MR; (vi) displaying, from a message access URL, and upon validation of the MR's authorization cookie, an image containing the key phrase only known by the MR for the sender of the message.
b. A set of TSs registered in and certified by the TVAL as valid;
c. An Email Client, which displays the image containing the key phrase recognized by the MR as authentic for the sender.
d. A Web Browser, used to access the TVAL's functionalities.

2. The system of claim 1, wherein TSs are registered in and certified by the TVAL as authentic.

3. The system of claim 1, wherein users (TSs and MRs) are authenticated by the TVAL by means of a cookie created from a unique URL sent to the user's email address.

4. The system of claim 1, wherein a public access URL is created by the TVAL for each TS; said URL used by MRs to register the TS as trusted.

5. The system of claim 1, wherein an MR registers a TS as trusted by entering a key phrase only known by the MR, and an image is created containing the key phrase entered by the MR.

6. The system of claim 1, wherein the TS, by invoking the TVAL with its private application key, and for each email message sent to a MR, creates a unique message access URL and inserts such URL at the beginning of the email message.

7. The system of claim 1, wherein a MR, upon receipt of an email message, and by means of the email client and the message access URL, obtains an image from the TVAL containing a key phrase only known by the MR, and used by the MR to authenticate the TS as trusted.

8. The system of claim 1, wherein the TVAL restricts the display of an image from a message access URL by validating an authentication cookie sent by the MR's email client or web browser.
